(19) United States
(12) Patent Application Publication
(10) Pub. No.: US 2007/0174563 A1
(43) Pub. Date: Jul. 26, 2007

(54) System and method for selecting memory locations for overwrite

(76) Inventors: Stuart Staniford, San Francisco, CA (US); Mayuresh Mangesh Bakshi, Pune (IN)

Correspondence Address: PATRICK REILLY, P.O. BOX 7218, SANTA CRUZ, CA, 95061-7218, US

(21) Appl. No.: 11/337,978

(22) Filed: Jan. 23, 2006

(51) Int. Cl. G06F 13/00

(52) U.S. Cl. 711/159

(57) ABSTRACT

A method and information technology system are provided that enable a one-pass automated selection of memory locations of a table to be made available for storing new data may be applied to clear memory space of the table as the table approaches an overload condition. A fraction of the memory locations of the table to be made available for overwriting is established. The memory locations store a formatted record, and a parameter of the records stored in the memory locations is chosen for use in processing the table. In one example, a time parametric value of the records is chosen, and the memory locations holding records having time values older than a G value are released for overwriting, where G is a variable that is iteratively calculated. The records are analyzed serially in pluralities or blocks and the G value is examined after each block is processed for recalculation in order to more closely achieve the removal of the established fraction of records from the remaining unexamined blocks. In various versions, the records may be stored in the table according to an order or alternatively in a random or randomized sequence.

### FIELD OF THE INVENTION

The present invention relates to the systems and methods for information processing of electronic communications networks. More particularly, the present invention relates to techniques and systems for processing information, messages and activity logs related to electronic communications, to include information related to the activity and security of an electronic communications network and resources thereof.

### BACKGROUND OF THE INVENTION

The operations of electronic communications networks are often protected by the application of intrusion detection systems and intrusion prevention systems to include firewalls. The prior art techniques for management of many information detection systems (hereafter “IDS”) and information prevention systems (hereafter “IPS”) provide for the establishment of hash tables, wherein each entry in the table is a flow table record of communication between a source and an intended destination of an electronic message. The performance made possible by hash tables in prior art IDS and IPS is increased when the hash table is maintained with records that are more likely to contain information useful to IDS and IPS as applied, and wherein the hash table is maintained in a memory device that enables quick access by a relevant processor of the IDS or IPS. In the prior art most hash tables have a limited magnitude of memory size, and to avoid overflowing the table records are therefore archived, or simply deleted, from the hash table as the flow table records age. It is understood that within a computer system a cache memory on-chip with a processor provides quicker access to the instant processor than either off-chip cache memory or a main memory of a computer system.

In the alternative, a flow table record may include aggregated information related to activity of a particular source or, still alternatively, a flow table record may include aggregated information related to activity of a particular destination. Accordingly, a source flow table may include a plurality of source flow table records, wherein each source flow table record comprises aggregated information related to at least one message related to a particular source. Prior art destination hash tables may include a plurality of destination flow table records, wherein each destination flow table record comprises aggregated information related to at least one message related to a particular destination.

Addressing electronics communications network security management, prior art IDS and IPS techniques typically entail the analysis of message content for patterns or indications of undesired activity and/or suboptimal states of equipment of or coupled with the instant communications network. The efficiency of message traffic analysis is often improved when information extracted from messages is quickly accessible to a computational engine tasked with analyzing the message information. In particular, the tools of trend analysis are often applied to estimate a probability that a computational system or other equipment of, or communicating with, the communications network, upon the basis of examining pluralities of message information relating to a system or an equipment.

These prior art tables, which are possibly configured as hash tables, may be constrained in the memory space available for storing information, as on-chip and off-chip caches have finite memory locations and may be required to support multiple critical processes of a host computer. Yet, if the host computer is monitoring an electronic communications traffic of significant volume, the table may be overloaded very quickly, e.g., within five minutes or less. A common prior art technique is to archive information stored in the table on the basis of a time value of a time parameter contained within or associated with each record of the table, wherein records are deleted from the table in order of deleting the records with older time values first. The deletion of records on the basis of a single parameter, however, is a brute force technique that deprives the processor of rapid access to records that are more likely to be of interest than records that are associated with newer records of less of significance.

When the table is approaching an overload condition, the maintenance of the host system in a more optimal state of operation may require a rapid release of memory locations from storing previously received records and promptly making the newly released memory locations available to record more recently generated or received records. There is therefore a long felt need to provide efficient systems and methods that enable a selection for deletion of records stored in a table.

### SUMMARY OF THE INVENTION

Towards these objects, and other objects that will be made obvious in light of the present disclosure, a method and system are provided to select records for deletion from table, i.e. a data structure in a single pass through the table. In a first preferred embodiment of the Method of the Present Invention records are stored in a table maintained in a memory of a computational system, e.g., a main memory, an on-chip cache of a processor of the computational system, or an off-chip cache memory coupled with a processor of the computational system. Each record is associated with a memory address unique within the table. As the table fills up, and the table receives, or is likely to soon receive, more records than it can simultaneously store, records are selected for archival in a secondary memory and the memory locations associated with the memory address having stored the archived record are then released to store an alternate record. Records are deleted from the table on a periodic basis as well as in response to the table approaching or achieving an overload condition. In an overload condition the table has so few memory locations available for storing additional records that the host system can not, or is likely to not, be able to store newly generated or received records that have not yet been stored in the table.

In certain alternate preferred embodiments of the Method of the Present Invention, an overload condition is reached when 30% or less of the memory locations of the table are free to accept a new insertion of a record. Upon detection of an overload condition table is then pruned of records with the aim of reaching a table condition wherein 40% of the memory locations of the table are available to accept a new insertion of a record.

In the first preferred embodiment of the Method of the Present Invention (hereafter “first method”), the host computer (hereafter “first system”) is programmed, or programmed to derive, a value C, where C is a fraction or percentage of memory locations of the table preferred to be available for storing additional records at a given or specified moment or software execution step. In one exemplary alternate embodiment of the first method, the first system may derive a C value of 40 per cent, and the first system attempts to maintain the table in a state where approximately 40 per cent of the memory locations of the table are typically available to store additional records, or the table is either periodically and/or upon an overload condition detection reset to maintain at least or approximately 40 per cent of the memory locations of the table available for overwrite. Towards this end first system will sample a first plurality of memory locations of the table, calculate a quality value of a parameter of each record stored in the first plurality of memory locations, and select each record having a quality value below a certain value G for transfer from the on-chip memory and deletion from the table. It is understood that the terms “deletion” and all conjugations of the verb “to delete” are defined herein to include the function of making a memory location storing an information or record to be made available to be overwritten and available to store another or an alternate information or record.

After the first system has completed sampling the first plurality of memory location and the deletion of selected records, the first system then determines a fraction FR of memory locations of the first plurality of memory locations that are available for storing new or alternate records. It is understood that the first plurality of memory locations may include memory locations that were available for overwrite prior to the initiation of the sampling of the first plurality of memory locations.

In the first method, if the FR value of the first sampling is higher than C, than an undesirably high fraction of memory locations of the first plurality of memory locations are available for overwriting with additional records, and the outcome of the first sampling indicates that the G value should be lowered for the next sampling in an attempt to increase the probability that the FR value resulting from the next sampling will be closer to the C value. Alternatively, if the FR value is lower than C, than an undesirably low fraction of memory locations of the first plurality of memory locations are available for overwriting with additional records, and the outcome of the first sampling indicates that the G value should be raised for the next sampling in an attempt to increase the probability that the FR value of the next sampling will be closer to the C value. It is understood that C and FR may be expressed as numerical values.

In certain other alternate preferred embodiments of the Method of the Present Invention the G value is initiated as a preselected, previously generated, previously derived, randomly generated, or pseudo-randomly generated numeric value, and the G value is modified after each sampling of a plurality of memory locations. In an initialization phase, the G value may be divided by a number greater than one where the most recently calculated FR is greater than the C value, or multiplied by a number that is greater than one when the most recently calculated FR is smaller than the C value. In yet another exemplary alternate preferred embodiment of the Method of the Present Invention, the G value is halved where the most recently calculated FR is greater than the C value, and doubled when the most recently calculated FR is smaller than the C value.

In certain still alternate preferred embodiments of the Method of the Present Invention a G_LOW value and a G_HIGH value are derived and the G value is made equal to one half of the sum of G_LOW and G_HIGH. The G_LOW value is set as the highest value of G that has yielded an FR value lower than C in a plurality sampling, and G_HIGH is set as the lowest value of G that has yielded an FR value higher than C in a plurality sampling. When a G value is found to be higher than G_LOW and yield an FR lower than C, the G_LOW is set to the instant G value. When a G value is found to be lower than G_HIGH and yield an FR higher than C, the G_HIGH value is set to the instant G value. The G_LOW and G_HIGH values thus tend to generally converge towards each other in many applications of the Method of the Present Invention.

The quality value against which the G value is compared may be a sole parametric value related to or contained within an instant record, or may be derived from an algorithm that includes one, two or more weighted or unweighted values related to or contained within the instant record. For example, the quality value may be equal to a priority value of a record. In another example, the algorithm may include a time of generation value and a weighted priority value, wherein quality values of records having higher priority values will produce higher quality values than records having the same time generation value but lower priority values.

It is understood that in various alternate preferred embodiments of the Method of the Present Invention, the plurality of memory locations may comprise a contiguous or sequential block of memory addresses, and that in other alternate preferred embodiments of the Method of the Present Invention the plurality of memory locations may comprise a memory locations and addresses that are substantively non-sequential or non-contiguous. The sampling of non-contiguous or non-sequential memory locations or addresses may be affected in order to obtain a more randomized selection of records in a record sampling, evaluation and selected deletion process.

It is understood that in certain yet various alternate preferred embodiments of the Method of the Present Invention the G value may be inverted and/or records are deleted on the basis of a quality value derived from the record, or information related to the record, that is greater than the G value.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. A presents the outcomes of deleting information by means of comparison with a quality factor;

FIG. B is a flow chart of the application and modification of the quality factor of FIG. A;

FIG. C is a flow chart of the use and modification of the quality factor of FIG. A during an initialization period;

FIG. D is a flow chart of the use and modification of the quality of factor of FIG. A after the initialization period of FIG. C has ended;

FIG. 1 is a schematic of a computational engine, or first system, coupled with an electronic communications network;

FIG. 2A illustrates a flow table record stored in the first system of FIG. 1;

FIG. 2B illustrates a source flow table record stored in the first system of FIG. 1;

FIG. 2C illustrates a destination flow table record stored in the first system of FIG. 1;

FIG. 3 is a diagram of the table maintained in the first system of FIG. 1 and storing a plurality of records of at least one format selected from FIGS. 2A through 2D;

FIG. 4 is a flowchart of a first preferred embodiment of the Method of the Present Invention, or first method, that may be executed by means of the first system of FIG. 1;

FIG. 5 is a flowchart of a second preferred embodiment of the Method of the Present Invention, or second method, that may be executed by means of the first system of FIG. 1;

FIGS. 6A and 6B comprise the initialization process of the second method of FIG. 5; and

FIGS. 7A and 7B comprise the main cycle of the second method of FIG. 5.

### DETAILED DESCRIPTION OF THE PREFERRED EMBODIMENT

The following description is provided to enable any person skilled in the art to make and use the invention and sets forth the best modes contemplated by the inventor of carrying out his or her invention. Various modifications, however, will remain readily apparent to those skilled in the art, since the generic principles of the Present Invention have been defined herein.

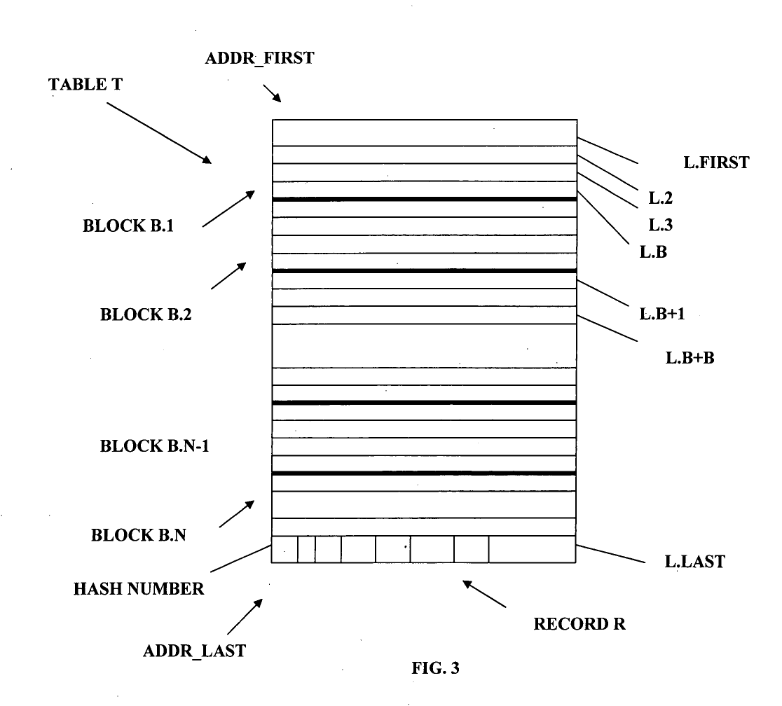

Referring now generally to the Figures and particularly to Figures A, B, C and D, describe the logical flow of a first preferred Method of the Present Invention (hereafter “first version”). FIG. A is a chart of the outcomes of the processing of at least four pluralities of records B of a Table T of FIG. 3. In the first record, a G_FLOW of each non-deleted record R of a plurality B is calculated and then compared against a G value. Records having G_FLOW values less than the G value are then deleted. After each plurality B is processed, a ratio FR is calculated, the ratio FR being equal to (a.) the count of memory locations L of the instant plurality B that are (after the selection and deletion process) available for storing new or additional records R, to (b.) the total number of memory locations of the instant plurality B. The FR value is then compared to a target ratio of C. Where FR is less than C, fewer than desired memory locations L are available for storage, and the G value is therefore raised in processing a next plurality B of memory locations with the intent to erase a higher proportion of records R to produce a larger FR value from processing this following plurality B.

Where a resultant FR is too large, and more than targeted memory locations L are thereby shown to be available for overwriting, the G value is lowered with the intent to reduce the number of records R deleted in processing a following plurality of records B.

Referring now generally to the Figures and particularly to Figures A and B, consider the processing of a block B.K and a following processing of a block B.K+1. After processing the plurality B.K, wherein this processing includes the steps of selecting and deleting records R of the plurality B.K, the resultant FR.K of the processing of the plurality B.K is compared against a C value. Where FR.K is greater than C, the G value is then decreased with the intent to erase fewer records R in processing the next plurality B.K+1. Where FR.K is less than C, the G value is then increased with the intent to erase more records R in processing the next plurality B.K+1. Where FR.K equals C, the G value is not modified.

Referring now generally to the Figures and particularly to FIG. C., the raising and lowering of the G value after processing each plurality B may be affected by dividing the G value by a number greater than one to decrease the G value in an attempt to reduce the number of records R to be deleted in a following plurality processing, or conversely the G value may be multiplied by a number greater than one to increase the G value and attempt to increase the number of records R to be deleted in processing a next plurality of records B. FIG. C presents examples of alternatively halving and doubling the G value as illustrative only and not limiting. The steps of FIG. C may be applied in an initialization phase of certain preferred embodiments of the Method of the Present Invention, as further described below in reference to the first method and a second preferred Method of the Present Invention (hereafter “second method”).

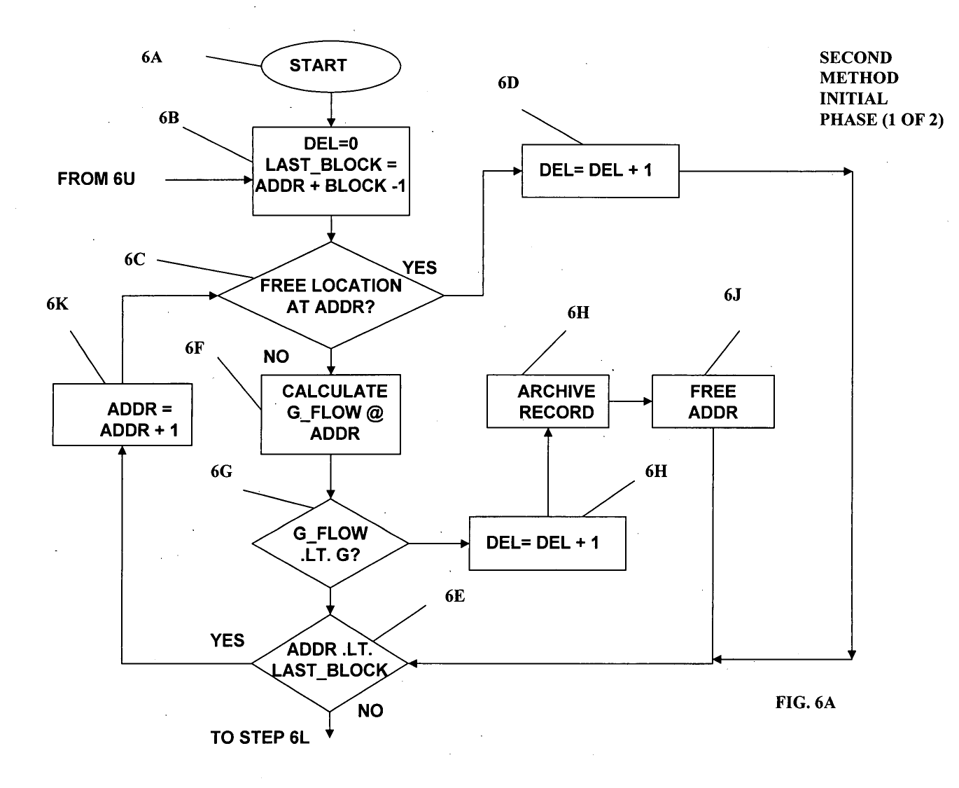

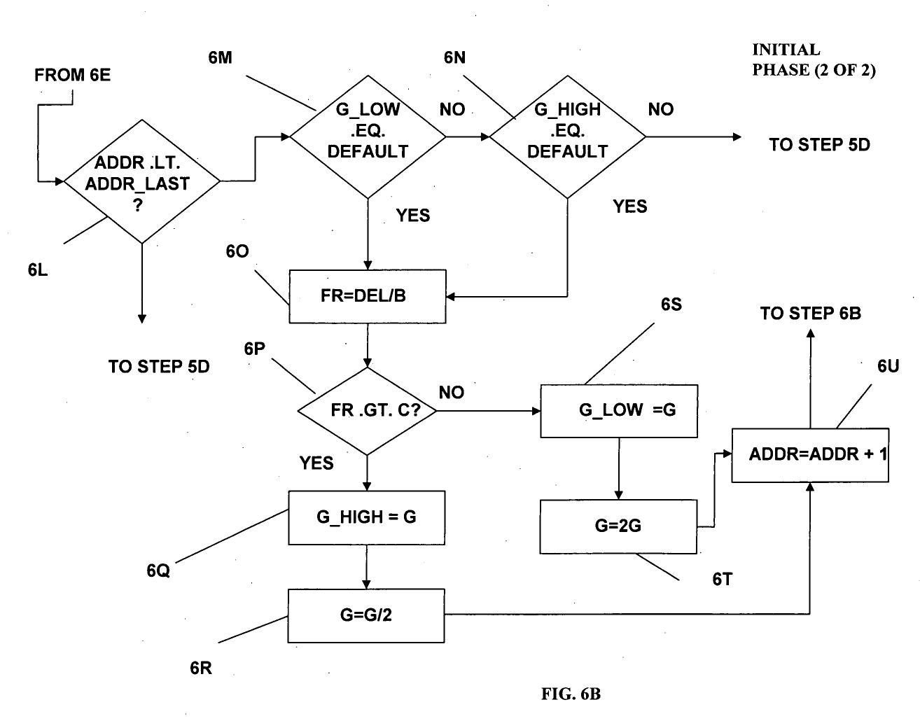

Referring now generally to the Figures and particularly to FIG. D, the raising and lowering of the G value are accomplished in a main cycle of the second method by altering the values of a G_LOW value and a G_HIGH value. The initialization of the G_LOW and G_HIGH values are discussed below in reference to the second method, and particularly in reference to FIGS. 6A and 6B. In the second method, the G value is typically raised by increasing the G_LOW value, and the G value is typically lowered by decreasing the G_HIGH value. In the main cycle of the second method the resultant FR of each plurality B processing is compared against the targeted C value. Where FR is less than C, too few memory locations L are available for overwriting. The G value might then be raised with the intent to erase more records R in the next plurality B processing. Where the G value is higher than the current G_LOW value (and the current FR is less than C), the G_LOW value is made equal to the G value and the G_LOW value thereby increased.

Referring still generally to the Figures and particularly to FIG. D, where FR is greater than C, too many memory locations L are available for overwriting. The G value might then be lowered with the intent to erase fewer records R in the next plurality B processing. Where the G value is lower than the current G_HIGH value (and the current FR is greater than C), the G_HIGH value is made equal to the G value and the G_HIGH value is thereby decreased. The G value is then modified by being made equal to the one half of the sum of the updated G_LOW and G_HIGH values.

It is understood that in still additional alternate preferred embodiments of the Method of the Present Invention the comparison of the G value with G_FLOW may be made wherein records with G_FLOW values greater than the G value are selected and deleted, wherein the logic flow of the Method of the Present Invention is modified to update the G value accordingly.

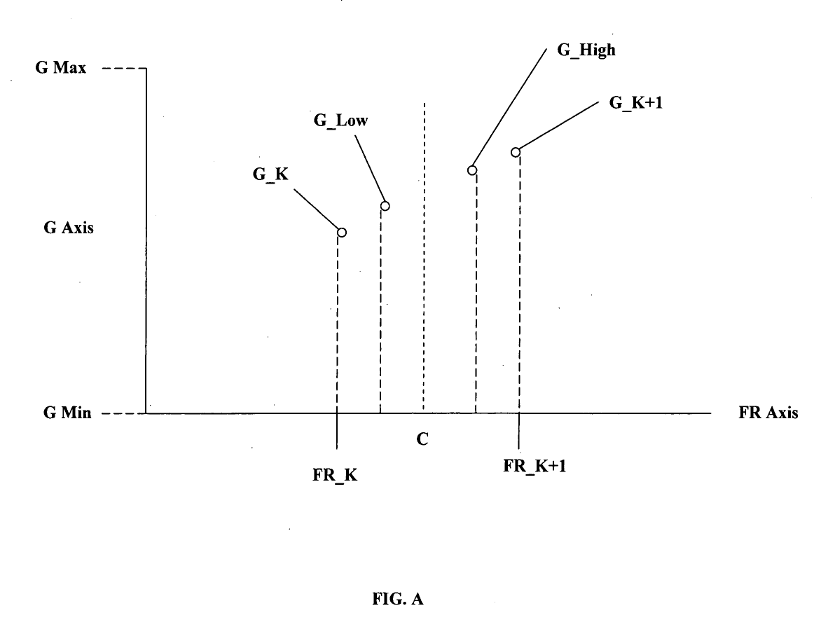

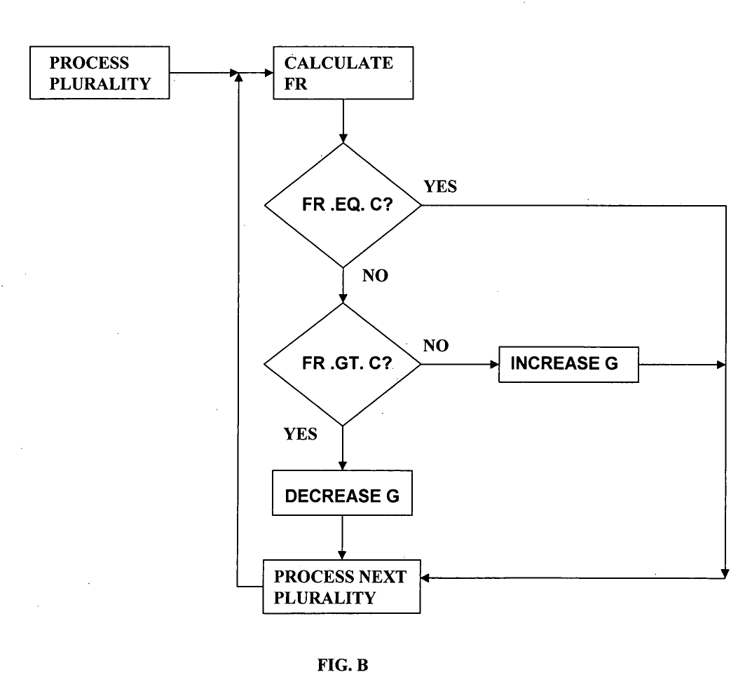

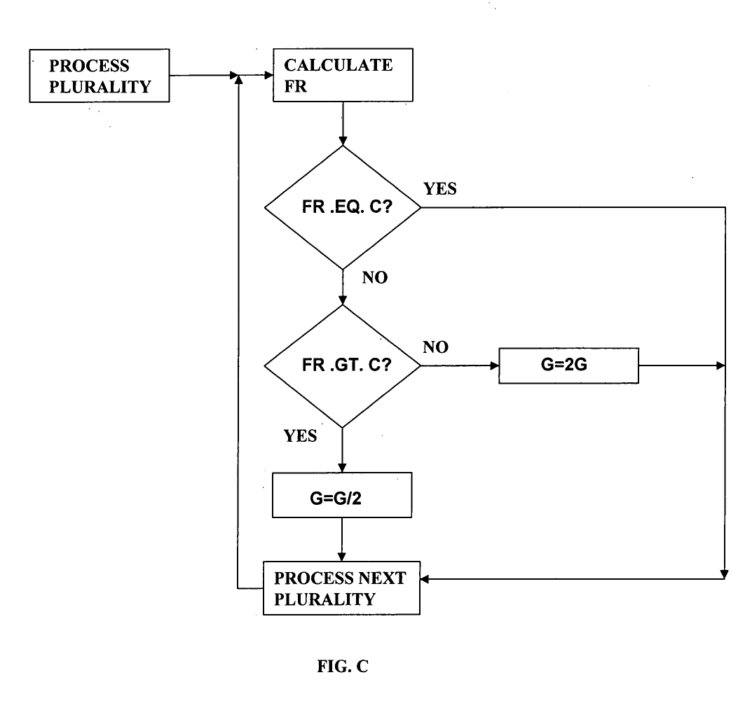

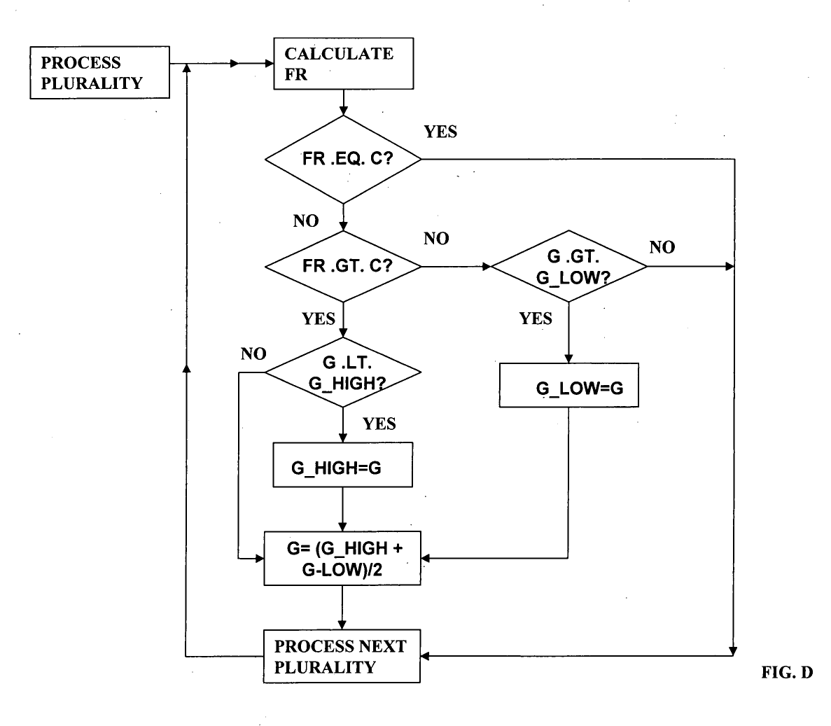

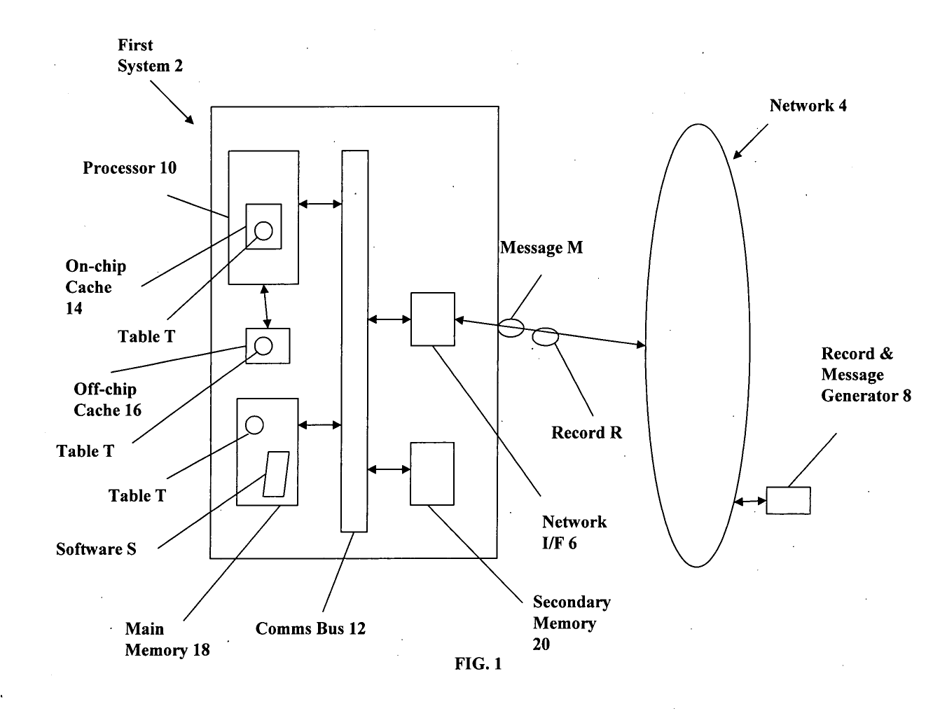

Referring now generally to the Figures and particularly to FIG. 1, FIG. 1 presents FIG. 1 is a schematic of a computational engine 2, or first system 2, coupled with an electronic communications network 4. Messages M and records R are received by the first system 2 from the network via a network interface 6 of the first system 2. The messages M ands records R may are generated by one or more external computational engines 8 that are comprised within or communicatively coupled with the network 4. The network 4 may be, or comprise, or be comprised with the Internet, and/or one or more suitable electronic communications networks known in the art.

The messages M and records R are communicated to a processor 10 of the first system 2 by means of an internal communications bus 12. The processor 10 may store the records R in a table T, wherein the table T is optimally stored in an on-chip cache memory 14 of the processor 10. Alternatively or additionally, the processor 10 may extract information contained within, derived from, related to, or associated with one or more messages M to generate one or more records R, and thereupon store the generated records R in the table T. Less optimally, the first system 2 may store some or all of the table T in an off-chip cache 16, and even less optimally in a system memory 18. One or more records R and/or messages M may be archived in a secondary memory 20 of the first system 2 before or after deletion of a stored record R, or an associated record R, from the table T.

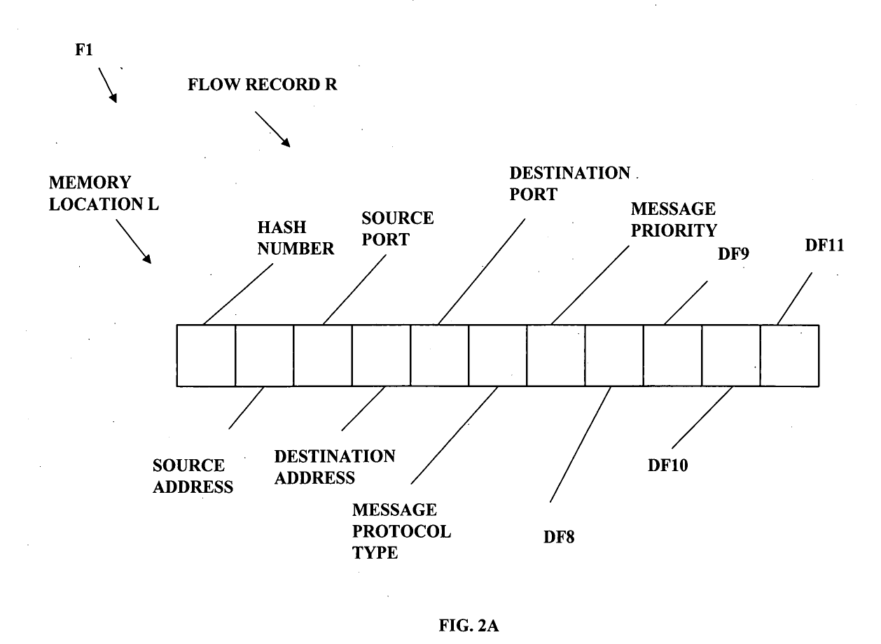

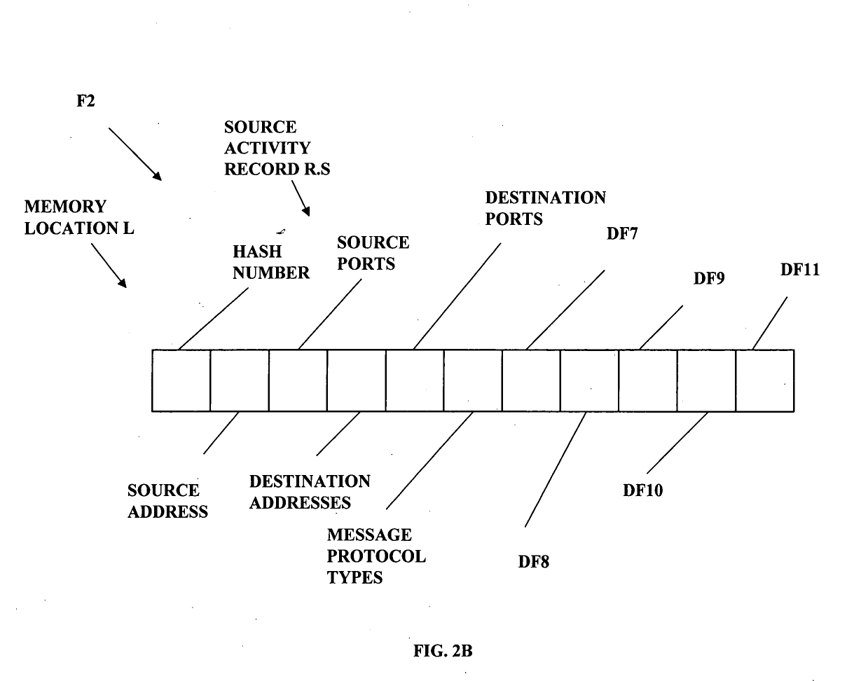

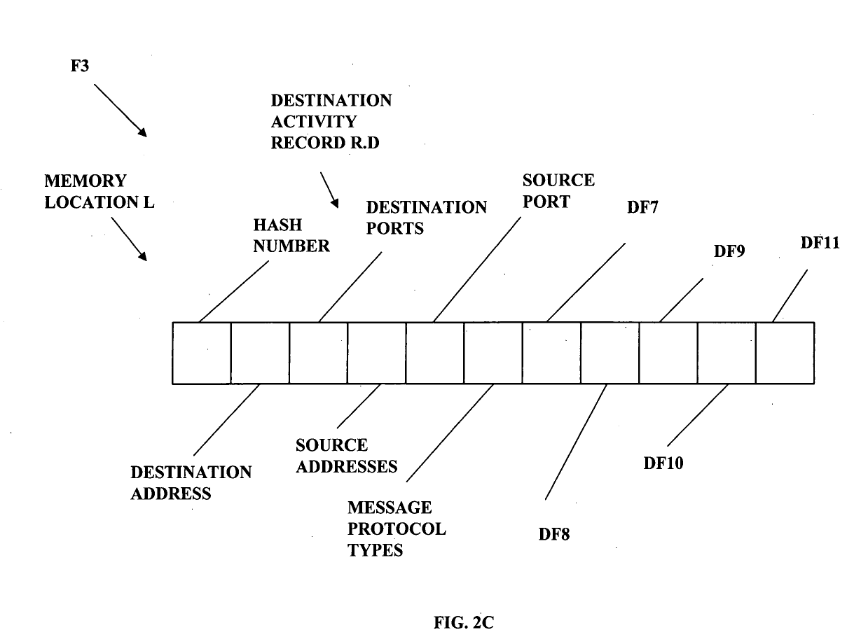

Referring now generally to the Figures and particularly to FIGS. 2A through 2C, FIGS. 2A through 2C are examples of formats of records that may be stored in a table maintained in a memory device of the first system of FIG. 1. FIG. 2A is a schematic of a first format F1 of a flow table record R as stored in a memory location L of a table T. The flow table record R is may be a record of a connection between a source and a destination of the communications network 4, wherein the message M is formatted according to the TCP/IP format. The memory location L includes both the flow table record R and a hash number derived at least partially from the information contained in flow table record R. The flow table record R stores information related to a particular message M, such the TCP/IP compliant source address and source port of that message M, the TCP/IP compliant destination address and the destination port of the same message M, a message protocol identifier, and an event priority of the same message M. The flow table record R may further comprise additional information related, associated with or derived from the same message M in additional data fields DF.7 through DF.11, such as state tables related to or generated by an intrusion detection system, an intrusion prevention system, and/or a firewall. It is understood that the exemplary reference to the TCP/IP protocol is made for illustrative purposes only and is not limiting to the scope of the invention as disclosed and claimed.

Referring now generally to the Figures and particularly to FIG. 2B, FIG. 2B is a schematic of a second format F2 of a source flow table record R.S as stored in a memory location L of the table T that stores a source flow table record R.S, and a hash number derived at least partially from the information contained in source flow table record R.S. The source flow table record R.S includes information related to a plurality of messages M having a same source and communicated by means of the network 4. The source flow table record R.S. contains a same originating source address (and one or more source ports thereof) of the selected plurality of message M, optionally the destination addresses and the destination ports of at least some of the same plurality of messages M. The source flow table record R.S may further comprise additional information related, associated with or derived from one or more of a plurality of messages M as stored in additional data fields DF7 through DF11.

Referring now generally to the Figures and particularly to FIG. 2C, FIG. 2C is a schematic of a third format F3 of a destination flow table record R.D as stored in a memory location L of the table T that stores a destination flow table record R.D, and a hash number derived at least partially from the information contained in the destination flow table record R.D. The destination flow table record R.D includes information related to a plurality of messages M having a same source and communicated by means of the network 4. The destination flow table record R.D contains a same originating destination address (and one or more destination ports thereof) of the selected plurality of message M, optionally the destination addresses and the destination ports of at least some of the same plurality of messages M. The destination flow table record R.D may further comprise additional information related, associated with or derived from one or more of a plurality of messages M as stored in additional data fields DF7 through DF11.

Referring now generally to the Figures and particularly to FIG. 3, FIG. 3 is a diagram of the table T maintained in the first system of FIG. 1 and storing a plurality of records R, R.S and R.D in memory locations L.FIRST through L.LAST. The address of memory location L.FIRST (hereafter “ADDR_FIRST”) is the initialize address examined in an evaluation cycle of the first method as discussed below. The address of the last memory location L.LAST is the address identified as LAST_ADDR as discussed below. The records R, R.S and R.D may be stored within the table T as organized within blocks of memory locations having contiguous or sequential addresses. A Block B.1 comprises a plurality of memory locations L.FIRST through L.B. The memory locations of the table T are organized in a plurality of blocks B.1 through B.N, each Block B.1 through B.N comprise a quantity of B sequentially addressable memory locations. Each record R, R.S and R.D stored in a memory location L.FIRST through L.LAST instantiates at least one format F1, F2, & F3 as illustrated in FIGS. 2A through 2C.

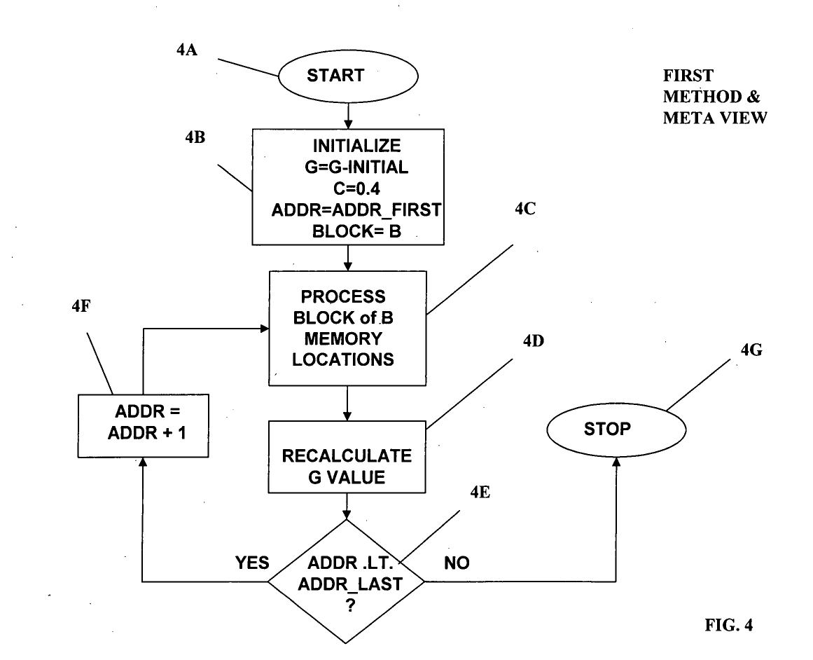

Referring now generally to the Figures and particularly to FIG. 4, FIG. 4 is a flowchart of a first preferred embodiment of the Method of the Present Invention, or first method, that may be executed by means of the first system of FIG. 1 and a software S. The software S comprises machine readable instructions provided to the first system 2 that directs the first system 2 to execute one or more of the steps of FIGS. 4, 5, 6A, 6B, 7A & 7B. In steps 4A through 4G an evaluation cycle is applied to the table T. In step 4B a plurality of values and variables used in the first method are initialized, to include a C value, a G variable and a memory address variable ADDR. In step 4C a G_FLOW variable is derived from records, as each is held in one of a plurality of N memory locations identified by N addresses. The G_FLOW values are each then individually evaluated against the value of the G variable, and records having a G_FLOW quality value less than the G variable are deleted. The N memory locations may be contained within a block of table T instantiated by means of a contiguous series of memory locations within a memory 16, 16 & 18 and/or identified by a sequential series of addresses. In step 4D the results of the deletions affected in step 4C are evaluated, and the G variable may be recalculated to in view of these results, in an attempt to increase or decrease the number of records to be erased in a next processing of a following plurality N memory locations. In step 4E the first system 2 determines whether the table T has been completely evaluated, whereby the evaluation cycle has been completed.

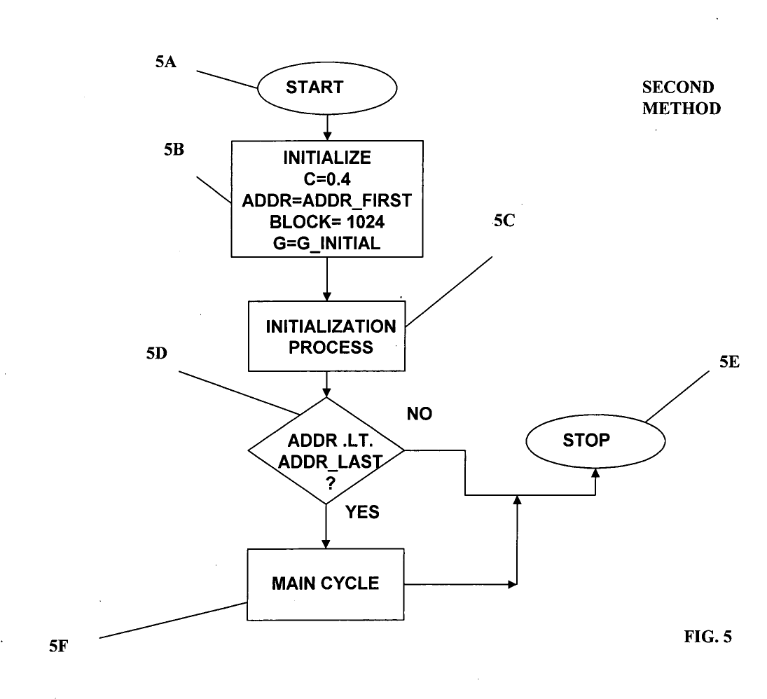

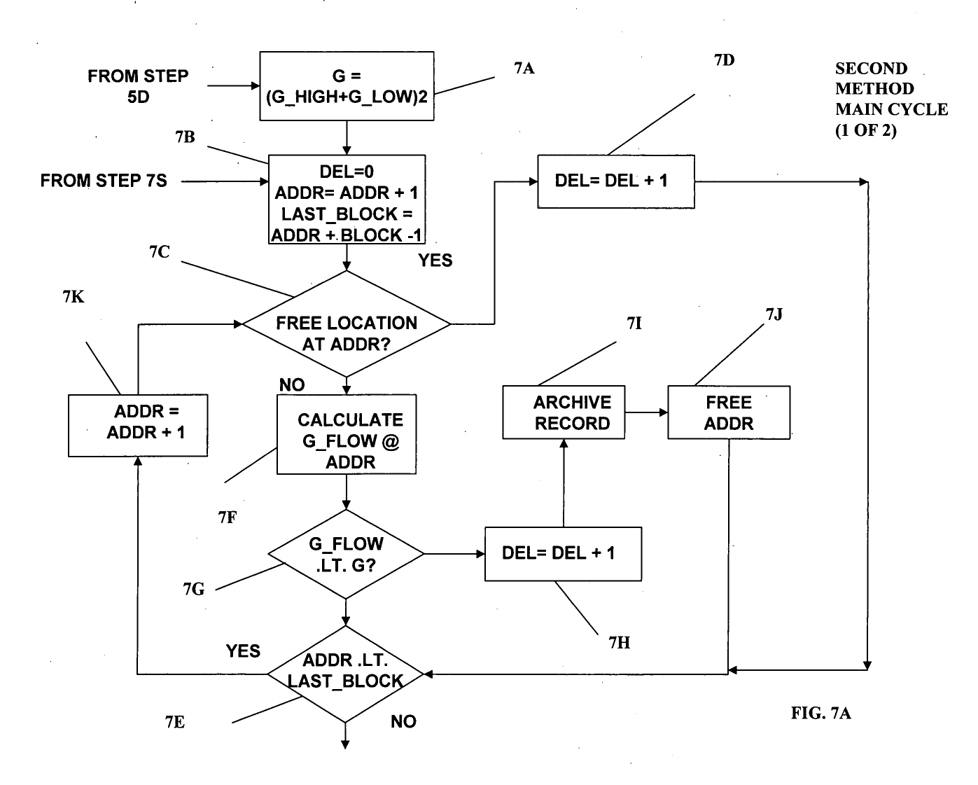

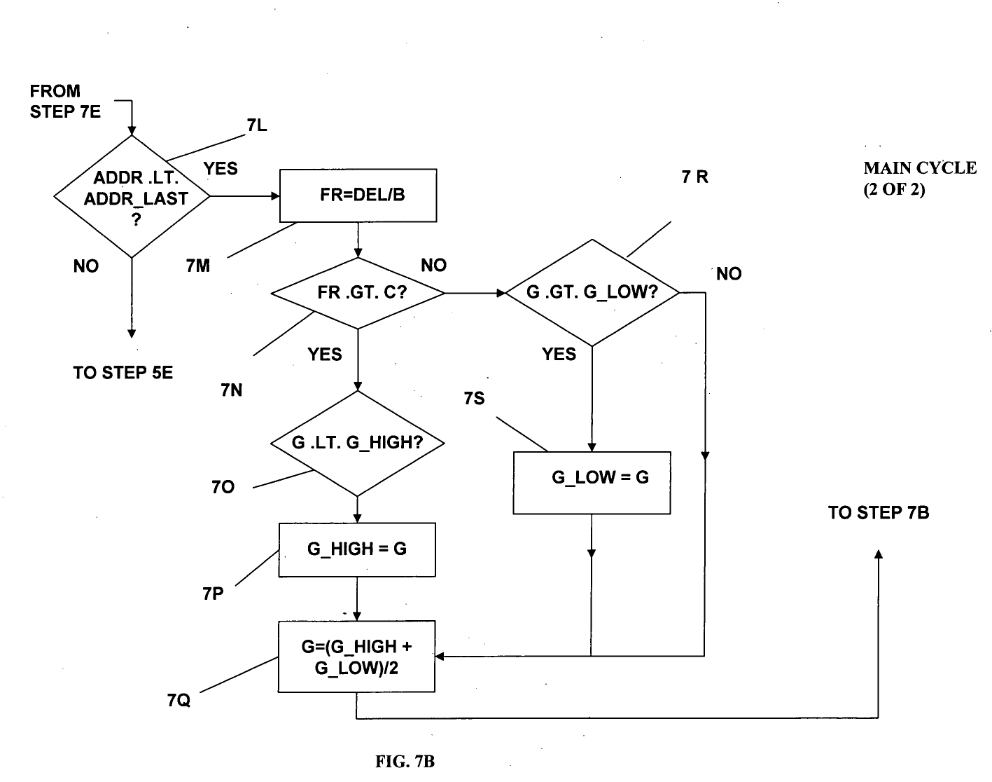

Referring now generally to the Figures, and particularly to FIG. 5, FIG. 5 is a flowchart of a second preferred embodiment of the Method of the Present Invention, or second method, that may be executed by means of the first system 2 of FIG. 1. In step 5B The C value, the G value, a BLOCK memory location count value, an ADDR_FIRST value and an ADDR_LAST value are initialized. In addition, a G_LOW value and a G_HIGH value are initialized as default values, e.g., non-numeric values, in step 5B. The ADDR_FIRST value is the first memory location address of the table T, wherein the memory address locations are sequentially numbered and the ADDR_FIRST value is the memory location address having the lowest numerical value and the ADDR_LAST value is the memory location address having the highest numerical value. The BLOCK value is the number of memory locations to be processed in a single processing of a plurality of memory location (in step 5C or step 5F) and that results in a new FR value. In step 5C two or more pluralities of 1024, i.e. the BLOCK value, of memory addresses are processed in an initialization phase, and in accordance with FIGS. 6A and 6B herein. The first system 2 proceeds on to step 5D when both a G_LOW value and a G_HIGH value are selected, where the technique for these two selections described in reference to FIG. 6B below. When the ADDR value is found to be equal to or greater than the ADDR_LAST value, the first system 2 proceeds on from step 5D to step 5E and stops processing the table T for records R stored therein to be selected and deleted. Where the ADDR value is found to be less than the ADDR_LAST value in step 5D, the first system 2 proceeds on to step 5F of the second method. In step 5F, and where G_LOW and G_HIGH have been selected the first system 2 executes a main cycle step 5F in accordance with the flowchart of FIGS. 7A and 7B until the ADDR value equals or exceeds the ADDR_LAST value. The first system 2 exits step 5F when the ADDR value equals or exceeds the ADDR_LAST value and proceeds on to step 5E, whereupon the table T has been substantively examined for selection and deletion of records R.

Referring now generally to the Figures, and particularly to FIGS. 5, 6A and 6B, FIGS. 6A and 6B comprise the initialization process step 5C of the second method of FIG. 5. In step 6B a DEL value is initialized to zero and a last address value (hereafter “LAST_BLOCK”) of the plurality B of memory locations L to be examined in the instant execution of the initialization process is set to be equal to the instant ADDR value plus the BLOCK value minus one. In step 6C the first system 2 determines whether the memory location at the address of ADDR is a free location, i.e., is available to accept a writing of a record R, is presently storing a record R and is unavailable for overwriting. Where the memory location examined in step 6C is presently free for overwriting, the first system 2 moves executes step 6D and proceeds directly on to step 6E. Where the memory location examined in step 6C is not presently free for overwriting, the first system 2 moves executes step 6F and calculates a G_FLOW value derived from the values of the record R. In step 6G the G_FLOW value calculated in step 6F is compared against a G value, wherein a record R from which a G_FLOW less than the present value of G is derived is (a.) selected for deletion and (b.) the memory location storing the instant record R is made available for overwriting. Where the G_FLOW value calculated in step 6F is less than the G value, the DEL value is incremented in step 6H. In optional step 61 the record selected for deletion is archived in a secondary memory 20 of the first system 2. In step 6J the memory location storing the record R is made available for overwriting, i.e., the record R is deleted from the table T. The first system 2 proceeds from either (a.) step 6G, when the most recently calculated G_FLOW is greater than or equal to the current G value, or (b.) step 6J to determine in step 6E whether the current value of ADDR is equal to the last address of the plurality B of memory locations L of LAST_BLOCK. Where the instant ADDR value does not equal LAST_BLOCK as examined in step 6J, the first system 2 increments the ADDR value in step 6K and proceeds back to step 6C to examine a next memory location. Alternatively, where the instant ADDR value does equal LAST_BLOCK as examined in step 6J, the ADDR value indicates that the each of the instant plurality B of memory locations L has been examined for comparison with the current G value, and the first system 2 moves on to execute step 6L of the initialization process of step 5C.

Referring now generally to the Figures and particularly to FIGS. 6A and 6B, in step 6L of FIG. 6B the first system 2 determines whether the instant ADDR value is greater than or equal to the last value ADDR_LAST of the table T, wherein when ADDR does equal or exceed the ADDR_LAST value, the first system 2 exits the initialization phase of step 5C and then proceeds on to execute step 5D. Alternatively, where the instant ADDR value examined in step 6L is not equal to or greater than the ADDR_LAST value, the first system 2 proceeds from step 6L to step 6M. When the G_LOW value is no longer equal to the default value as set in step 5B, and the G_HIGH value is also no longer set to the default value as set in step 5B, the first system 2 proceeds through steps 6M and 6N and on to step 5D. Where either G_LOW or G_HIGH are not yet selected, the first system 2 proceeds from either step 6M or 6N to calculate FR in step 6O, wherein FR is made equal to the DEL value divided by the BLOCK value. FR is thereby made equal to the fraction or percentage of memory locations L of the last examined plurality B of memory locations L that are available to store a record R. In step 6P the FR value as calculated in step 6O is compared against the C value. Where FR is greater than C, i.e., the number of presently available memory locations of the most recently examined plurality B of memory locations L is larger than desired, the G value shall be lowered with the intent to erase fewer records R in processing a next plurality B of memory locations L. Where FR is less than or equal to C, i.e., the number of presently available memory locations of the most recently examined plurality B of memory locations L is fewer than desired, the G value shall be increased with the intent to erase more records R in processing a next plurality B of memory locations L. Where the most recently calculated FR value is greater than the C value, the first system 2 (a.) sets G_HIGH equal to the instant value of G in step 6Q, and (b.) divides the instant G value by 2, or another number greater than one, in step 6R. Alternatively, when the most recently calculated FR value is lesser than C as compared in step 6P, the first system 2 (a.) sets G_LOW equal to the instant value of G in step 6S, and (b.) multiplies the instant G value by 2, or another number greater than one, in step 6T. The first system proceeds on from either step 6S or step 6R to increment ADDR in step 6U, and therefrom step 6U to step 6B, whereby a next plurality B of memory locations L are examined in the initialization process of step 5C.

Referring now generally to the Figures and particularly to FIGS. 7A and 7B, when the first system 2 has proceeded through step 5D of the second method to the main cycle of step 5F, the main cycle of step 5F may be executed in accordance with the flow charts of FIGS. 7A and 7B. In step 7A the G value is recalculated to be equal to one half of the sum of G_HIGH and G_LOW. In step 7B (a.) the DEL value is initialized to zero, (b.) the ADDR value is incremented, and (c.) the LAST_BLOCK value of the next plurality B of memory locations L to be examined in the instant execution of the main cycle of step 5F is set to be equal to the instant (and newly incremented) ADDR value plus the BLOCK value minus one. In step 7C the first system 2 determines whether the memory location at the address in the table T of ADDR is (a.) available to accept a writing of a record R, or (b.) presently storing a record R and is unavailable for overwriting. Where the memory location L examined in step 7C is presently available for overwriting, the first system 2 executes step 7D by incrementing the DEL value and proceeds directly on to step 7E. Where the memory location L examined in step 7C is not presently free for overwriting, the first system 2 proceeds from step 7C and executes step 7F to calculate a G_FLOW value derived from the values of the record R. As determined in step 7G, where the G_FLOW value as calculated in step 7F is less than the current G value, the first system 2 executes step 7H and increments the DEL value. In optional step 7I the record R selected for deletion in step 7G is archived in a secondary memory 20 of the first system 2. In step 7J the instant memory location L having memory address ADDR storing the record R is made available for overwriting, whereby the record R is deleted from the table T. The first system 2 proceeds from either (a.) step 7G, when the most recently calculated G_FLOW is greater than or equal to the current G value, or (b.) step 7J, to determine in step 7E whether the current value of ADDR is equal, to the last address of the plurality B of memory locations L of LAST_BLOCK. Where the instant ADDR value does not equal LAST_BLOCK value as examined in step 7E, the first system 2 increments the ADDR value in step 7L and proceeds back to step 7C to examine a next memory location L. Alternatively, where the instant ADDR value does equal the LAST_BLOCK value as examined in step 7E, the ADDR value indicates that the each of the instant plurality B of memory locations L has been examined and the first system 2 moves from step 7E to execute step 7L of FIG. 6B.

Referring now generally to the Figures and particularly to FIGS. 7A and 7B, in step 7L of FIG. 6B the first system 2 determines whether the instant ADDR value is less than the last memory location value ADDR_LAST of the table, wherein when the ADDR value does equal or exceed the ADDR_LAST value upon the execution of step 7L, the first system 2 exits the main cycle of step 5F and then proceeds on to execute step 5E. Alternatively, where the instant ADDR value when examined in step 7L is determined to be less than the ADDR_LAST value, the first system 2 proceeds from step 7L to step 7M.

In step 7M of FIG. 7B the first system 2 calculates a current FR value as equal to the DEL value divided by the BLOCK value. FR is thereby made equal to the fraction or percentage of memory locations L of the last examined plurality B of memory locations L that are available to store a record R. In step 7N the FR value as calculated in step 7M is compared against the C value. Where FR is greater than C, i.e., the number of presently available memory locations of the most recently examined plurality B of memory locations L is larger than desired. Where FR is less than or equal to C, i.e., the number of presently available memory locations of the most recently examined plurality B of memory locations L is fewer than desired. In the main cycle the value of G is increased by increasing the G_LOW value, and the value of G is decreased by lowering the G_HIGH. Where the most recently calculated FR value is determined in step 7M to be greater than the C value, and the instant value of G is found to less than the current G_HIGH value as compared in step 70, the first system 2 lowers the G_HIGH value by making G_HIGH equal to the instant G value in step 7P. Lowering the G_HIGH value thereupon results in a low G value as derived in step 7Q. Where the most recently calculated FR value is determined in step 7M to be less than or equal to the C value, and the instant value of G is found to greater than the current G_HIGH value as compared in step 7R, the first system 2 raises the G_LOW value by making G_LOW equal to the instant G value in step 7S. Raising the G_LOW value thereupon results in a low G value as derived in step 7Q. After calculating a new instant G value in step 7P, the first system 2 proceeds on to step 7B

The above description is intended to be illustrative, and not restrictive. The examples given should only be interpreted as illustrations of some of the preferred embodiments of the invention, and the full scope of the invention should be determined by the appended claims and their legal equivalents. Those skilled in the art will appreciate that various adaptations and modifications of the just-described preferred embodiments can be configured without departing from the scope and spirit of the invention. The scope of the invention as disclosed and claimed should, therefore, be determined with reference to the knowledge of one skilled in the art and in light of the disclosures presented above.

We claim:

1. In an information technology system, the information technology system having a memory storing a table of information organized in blocks of N formatted records, each formatted record stored in one of a plurality of addressable memory locations, the method comprising:
a. Selecting for overwrite the memory locations of a first block storing records that have a first parametric value less than a value G;
b. Determining a fraction FR equal to number of memory locations selected for overwrite in step a divided by N;
c. Comparing FR to a value C, where C is the fraction of memory locations desired to be made available for overwriting; and
d. Recalculating G to more probably select for overwrite C memory locations of a second block.

2. The method of claim 1, wherein the method is applied when the table approaches an overload condition.

3. The method of claim 1, wherein the table is a hash table.

4. The method of claim 1, wherein the table is a flow table of electronic communications traffic.

5. The method of claim 1, wherein the formatted records comprise state tables of a firewall.

6. The method of claim 1 wherein, wherein the formatted records are state tables of an intrusion detection system.

7. The method of claim 1 wherein, wherein the formatted records are state tables of an intrusion prevention system.

8. The method of claim 1, wherein each formatted record contains information related to activity associated with a particular source address.

9. The method of claim 1, wherein each formatted record contains information related to communications behavior associated with a particular destination address.

10. The method of claim 1, wherein the parametric value is derived from at least one record value selected from the group of record values consisting of a time record value, an event priority record value, a destination address record value, and a source address record value.

11. The method of claim 1, wherein the G is recalculated in step d by dividing G by a number larger than 1 when FR is greater than C, and multiplying G by a number larger than 1 when FR is less than C.

12. The method of claim 1, wherein G is calculated to be equal to (G_HIGH+G_LOW)/2, wherein G_HIGH is greater than G_LOW, the step d comprising the elements of:
d.1. If FR calculated in step b is greater than C, and G is less than G_HIGH, than making G_HIGH equal to G;
d.2 If FR of step b. is less than C, and G is greater than G_LOW, making G_LOW equal to G; and
d.3 Recalculating G to be equal to (G_HIGH+G_LOW)/M after executing elements d.1 and d.2 of step d, wherein M is a number greater than one.

13. The method of claim 1, wherein each record comprises a plurality of record values, and the first parametric value is derived from at least one record value.

14. The method of claim 13, wherein the parametric value is derived from at least one record value selected from the group of record values consisting of a time record value, an event priority record value, a destination address record value, and a source address record value.

15. The method of claim 1, wherein each record comprises at least one record value, and the first parametric value is derived from at least one record value and an external value, the external value accessible to the information technology system. (NOTE: the external value is possibly an environmental value relating to the environment or state of the information technology system or an associated communications network.)

16. A computer-readable medium on which are stored a plurality of computer-executable instructions for performing steps (a)-(d), as recited in claim 1.

17. In an information technology system, the information technology system having a memory storing a table of information comprising a plurality of formatted records, each formatted record stored in one of a plurality of addressable memory locations, the method comprising:
a. Selecting a plurality of N records, the N records being selected substantively from non-contiguous memory location addresses;
b. Selecting for overwrite the memory locations of each of the records selected in step a that have a first parametric value less than a value G;
c. Determining a fraction FR equal to number of memory locations selected for overwrite in step a divided by N;
d. Comparing FR to a value C, where C is the fraction of memory locations desired to be made available for overwriting; and
e. Recalculating G to more probably select C memory locations for overwrite of a second plurality of N records.

18. The method of claim 17, wherein the method is applied when the table approaches an overload condition.

19. The method of claim 17, wherein the G is recalculated in step d by dividing G by 2 when FR is greater than C, and doubling G when FR is less than C.

20. The method of claim 17, wherein G is calculated prior to step a to be equal to (G_HIGH+G_LOW)/2, wherein G_HIGH is greater than G_LOW, the steps of:
e. If FR calculated in step c is greater than C, and G is less than G_HIGH, than making G_HIGH equal to G;
f. If FR of step c. is less than C, and G is greater than G_LOW, making G LOW equal to G; and
g. In step e, recalculating G to be equal to (G_HIGH+G_LOW)/M after executing steps h and i, wherein M is a number greater than one.

21. A computer-readable medium on which are stored a plurality of computer-executable instructions for performing steps (a)-(e), as recited in claim 17.

22. In an information technology system, the information technology system having a memory storing a table of information comprising formatted records, each formatted record stored in one of a plurality of addressable memory locations, the method comprising:
a. Initiating an evaluation cycle of records stored in the table for deletion from the table;
b. Setting a G value;
c. Setting a G_HIGH value to a maximum value;
d. Setting a G_LOW value to a minimum value
e. Selecting for evaluation the memory locations of a first plurality of N memory locations, each memory location configured for erasabley storing a record;
f. Deleting each record of the first plurality of N memory locations that have a first parametric value less than the value G;
g. Determining a fraction FR equal to number of memory locations selected for overwrite in step a divided by N;
h. Comparing FR to a value C, where C is the fraction of memory locations desired to be made available for overwriting; and
i. If FR is greater than C, and G is less than G_HIGH, then setting G_HIGH equal to G;
j. If FR is less than C, and G is higher than G_LOW, then setting G_LOW equal to G;
k. If G_LOW is greater than the minimum value, and G_HIGH is less than the maximum value, setting G equal to one half the sum of G_LOW and G_HIGH, and proceeding to step n;
l. If G_LOW is equal to the minimum value or G_HIGH is equal to the maximum value, and FR is greater than C, than setting G equal to one half of G;
m. If G_LOW is equal to the minimum value or G_HIGH is equal to the maximum value, and FR is less than C, than setting G equal to twice G; and
n. Selecting a following plurality of N memory locations and performing steps f through n until all memory locations of the table have been evaluated in the instant evaluation cycle then ending the evaluation cycle.
